(19) United States
(12) Patent Application Publication
(10) Pub. No.: US 2026/0200286 A1
(43) Pub. Date: Jul. 16, 2026

(54) LEAK RESISTANT AIR CONDITIONING ENCLOSURE FOR VEHICLES IN MOTION

(71) Applicant: Oscar Baumert, Grovetown, GA (US)

(72) Inventor: Oscar Baumert, Grovetown, GA (US)

(21) Appl. No.: 19/430,487

(22) Filed: Dec. 23, 2025

Related U.S. Application Data
(60) Provisional application No. 63/738,078, filed on Dec. 23, 2024.

(51) Int. Cl. B60H 1/00

(52) U.S. Cl. CPC B60H 1/00514; B60H 1/00557

(57) ABSTRACT

An enclosure for a vehicle air conditioning unit, the enclosure comprising a housing having an internal chamber, the internal chamber having a firewall positioned to define a first subchamber and a second subchamber, wherein the first subchamber is positioned proximate to a wall of the housing configured to be opposite a vehicle wall when the enclosure is mounted to a vehicle and the second subchamber is configured to be proximate to a vehicle wall when mounted to a vehicle and to receive an air conditioning unit; and a first set of one or more exhaust louver on a periphery of the first subchamber and a second set of one or more intake louver on a periphery of the second subchamber, the first and second sets of louvers allowing for air flow into and out of the enclosure. Air conditioning unit assemblies and vehicles including the enclosure are also disclosed, as are methods of reducing or preventing leaking of environmental water into an air conditioning unit mounted on a vehicle, using the enclosure.

### CROSS-REFERENCE TO RELATED PATENT APPLICATIONS

This application claims priority to and benefit of U.S. Provisional Patent Application Ser. No. 63/738,078, filed Dec. 23, 2024, the disclosure of which is incorporated herein by reference in its entirety.

### TECHNICAL FIELD

The subject matter disclosed herein relates generally to systems, devices, and methods for reducing or preventing leaks into and around air conditioning units for vehicles in motion. More particularly, the subject matter disclosed herein relates to leak resistant enclosures for air conditioning units for vehicles in motion, vehicles comprising the enclosures, and methods of using the enclosures to provide leak resistance.

### BACKGROUND

Air conditioning units are provided on a range of vehicles. A typical example of a vehicle is a travel trailer. A travel trailer is typically towed by another vehicle. Travel trailers can include an air conditioning unit mounted on the front wall or surface of the travel trailer, which is the surface that faces the vehicle that is towing the travel trailer. Thus, the air conditioning unit can be exposed to the elements, such as rain, wherein a risk of water leaking into and/or around the air conditioning unit arises.

### SUMMARY

In accordance with this disclosure, leak resistant enclosures for air conditioning units for vehicles in motion, vehicles comprising the enclosures, and methods of using the enclosures to provide leak resistance are provided.

In some embodiments, an enclosure for a vehicle air conditioning unit is disclosed. In some embodiments, the enclosure comprises: a housing having an internal chamber, the internal chamber having a firewall positioned to define a first subchamber and a second subchamber, wherein the first subchamber is positioned proximate to a wall of the housing configured to be opposite a vehicle wall when the enclosure is mounted to a vehicle and the second subchamber is configured to be proximate to a vehicle wall when mounted to a vehicle and to receive an air conditioning unit; and a first set of one or more exhaust louver on a periphery of the first subchamber and a second set of one or more intake louver on a periphery of the second subchamber, the first and second sets of louvers allowing for air flow into and out of the enclosure.

In some embodiments, each louver of the first set of one or more exhaust louver on a periphery of the first subchamber is angled toward a vehicle wall of the vehicle to which the enclosure is mounted. In some embodiments, each louver of the second set of one or more intake louver on a periphery of the second subchamber is angled toward a vehicle wall of the vehicle to which the enclosure is mounted. In some embodiments, the periphery of the first subchamber and the periphery of the second subchamber are positioned on a bottom surface of the housing.

In some embodiments, the enclosure further comprises a concave surface on a wall of the first set of one or more exhaust louver on the periphery of the first subchamber, wherein the wall is proximate to a wall of the housing configured to be opposite a vehicle wall when the enclosure is mounted to a vehicle.

In some embodiments, a vehicle air conditioning unit assembly is disclosed. In some embodiments, the assembly comprises an enclosure for a vehicle air conditioning unit as disclosed herein; and an air conditioning unit. In some embodiments, the assembly is mounted on a vehicle. In some embodiments, the vehicle is a travel trailer, a utility trailer, or a recreational vehicle.

In some embodiments, a vehicle comprising an enclosure for a vehicle air conditioning unit as disclosed herein is provided. In some embodiments, the vehicle comprises an air conditioning unit. In some embodiments, the vehicle is a travel trailer, a utility trailer, or a recreational vehicle.

In some embodiments, disclosed is a method for reducing or preventing leaking of environmental water into an air conditioning unit mounted on a vehicle. In some embodiments, the method comprises enclosing an air conditioning unit mounted on a vehicle with an enclosure as disclosed herein. In some embodiments, the vehicle is a travel trailer. In some embodiments, the vehicle is a travel trailer, a utility trailer, or a recreational vehicle.

Accordingly, it is an object of the presently disclosed subject matter to provide enclosures for a vehicle air conditioning unit, vehicles comprising the enclosure, vehicles comprising the enclosures, and methods of using the enclosures to provide leak resistance. Although some of the objects and aspects of the subject matter disclosed herein have been stated hereinabove, and which are achieved in whole or in part by the presently disclosed subject matter, other objects and aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a cross-sectional side view of an enclosure in accordance with the presently disclosed subject matter.

FIG. 2 is a cross-sectional side view of an enclosure in accordance with the presently disclosed subject matter, including arrows depicting flow of intake air and exhaust heat when the vehicle comprising the enclosure is stationary.

FIG. 3 is a cross-sectional side view of an enclosure in accordance with the presently disclosed subject matter, including arrows showing air flow when the vehicle is in motion.

FIG. 4 is a cross-sectional blown-up side view of an enclosure in accordance with the presently disclosed subject matter.

FIG. 5 is a bottom view of an enclosure in accordance with the presently disclosed subject matter.

FIG. 6 is a schematic cut-away perspective view showing general placement of an enclosure in accordance with the presently disclosed subject matter on a front wall of a vehicle.

### DETAILED DESCRIPTION

The presently disclosed subject matter relates to enclosures for an air conditioning unit for a vehicle, including a vehicle in motion. An example vehicle is a travel trailer, which is in motion, for example, when being transported by a user. In some embodiments, the enclosure shown here allows for a window unit air conditioner to be mounted at the front a moving vehicle without allowing water intrusion from the environment while in motion or parked.

Aspects of the presently disclosed enclosure include that no covers, tarps or similar are required to cover the enclosure during transportation. Also, in some embodiments, no manual levers or electronics are needed to keep the system free from water intrusion. Further, in some embodiments, the enclosure prevents mixing of intake and exhaust heat during air conditioner (AC) operation.

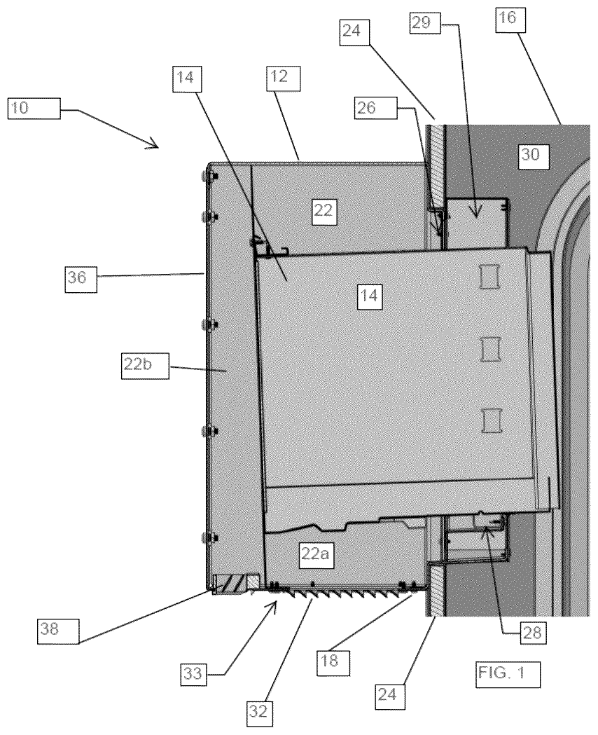

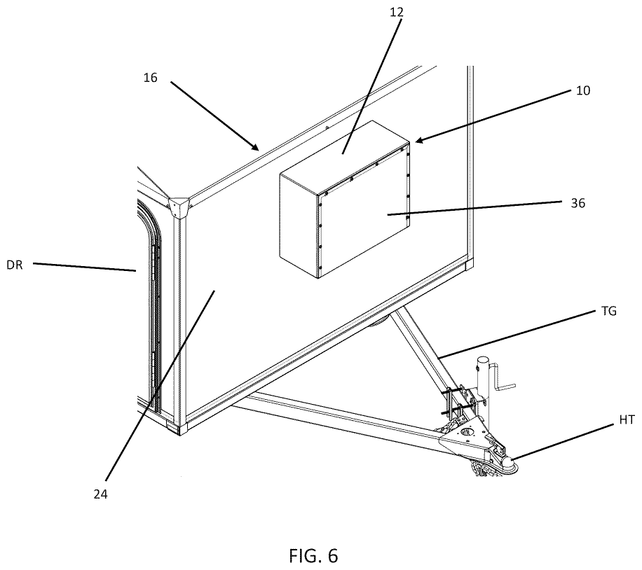

Referring to FIGS. 1-6, wherein like reference numerals refer to like parts throughout, a representative example enclosure of the presently disclosed subject matter is referred to generally at 10. Enclosure 10 comprises a housing 12 that is configured to be mounted over an air conditioner (AC) unit 14 on a vehicle 16. Vehicle 16 can be any vehicle having an AC unit where enclosing the AC unit might be desired. A particular example of vehicle 16 is a travel trailer, as shown in FIG. 6. Any suitable vehicle as would be apparent to one of ordinary skill in the art upon a review of the instant disclosure is provided in accordance with the presently disclosed subject matter. Other examples of vehicles include other trailers, such as utility trailers, and recreational vehicles. Vehicle 16 can include a door DR through which to access the interior 30 of the vehicle 16. As shown in FIG. 6, which is a schematic cut-away perspective view showing general placement of an enclosure in accordance with the presently disclosed subject matter on a front wall of a vehicle, vehicle 16 also includes a trailer tongue TG and a trailer hitch HT.

Continuing with reference to FIGS. 1-6, in some embodiments, housing 12 comprises a substantially rectangular box with an opening on one face of the box that receives the AC unit 14. Housing 12 includes an internal open space or chamber 22 wherein the AC unit 14 resides when enclosure 10 is mounted on vehicle 16. Housing 12 is mounted to wall 24 of vehicle 16 (which can be a front wall of the vehicle (shown generally in FIG. 6), or any desired wall of the vehicle) via a series of brackets and bolts 26 (or other suitable hardware as would be apparent to one of ordinary skill in the art upon a review of the instant disclosure). AC Unit 14 is mounted within the vehicle wall 24 of vehicle 16 using bracket assembly (bracket and screws into foot of AC unit) 28 and strap assembly/enclosure 29, such that the AC Unit 14 can provide conditioned air to the interior 30 of the vehicle 16 when in use by a user.

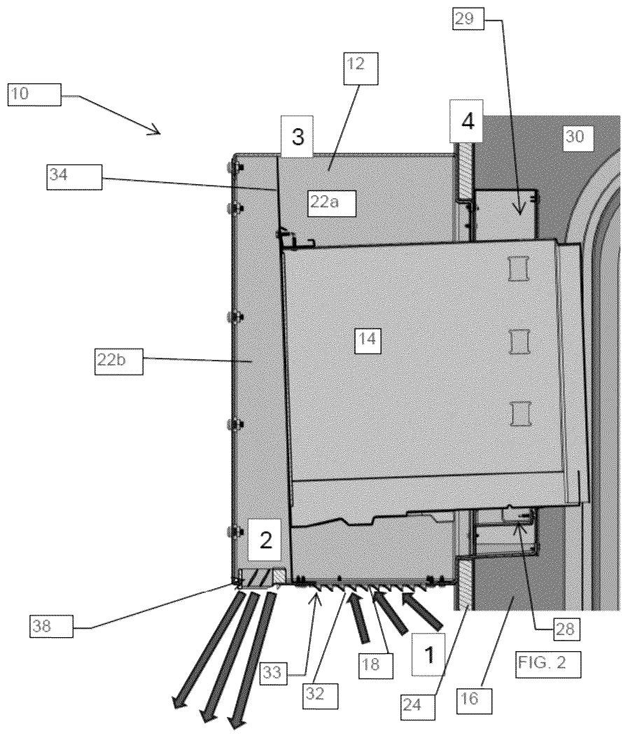

Continuing with reference to FIGS. 1-6, including with particular reference to FIG. 2, in stationary operation, rear facing intake louvers 32 on a periphery 33 of a bottom surface 18 of housing 12 in position 1 of FIG. 2 pull intake air shown by arrows from the vehicle wall 24 (position 1 in FIG. 2) forward. Exhaust heat from AC unit 14 is angled forward through exhaust louvers 38, such as angled at 30 degrees, on a periphery 33 of a bottom surface 18 of housing 12 to avoid mixing with intake air for the AC unit 14, as shown by arrows at position 2 in FIG. 2. A firewall panel 34 at location 3 of FIG. 2 stops mixing of intake and exhaust air from the AC unit 14 and further defines subchambers 22a and 22b within chamber 22. The AC unit 14 is sealed within subchamber 22a between firewall 34 and vehicle wall 24 (at position 4 in FIG. 2). Intake louvers 32 extend away from periphery 33 toward the exterior of enclosure 10 and are angled toward vehicle wall 24 at any suitable angle with respect periphery 33, including but not limited an angle ranging from 25 to 45 degrees, including an angle of 25, 26, 27, 28, 29, 30, 31, 32, 33, 34, 35, 36, 37, 38, 39, 40, 41, 42, 43, 44, or 45 degrees. Exhaust louvers 38 extend into subchamber 22b are angled toward vehicle wall 24 at any suitable angle with respect to periphery 33, including but not limited an angle ranging from 25 to 45 degrees, including an angle of 25, 26, 27, 28, 29, 30, 31, 32, 33, 34, 35, 36, 37, 38, 39, 40, 41, 42, 43, 44, or 45 degrees.

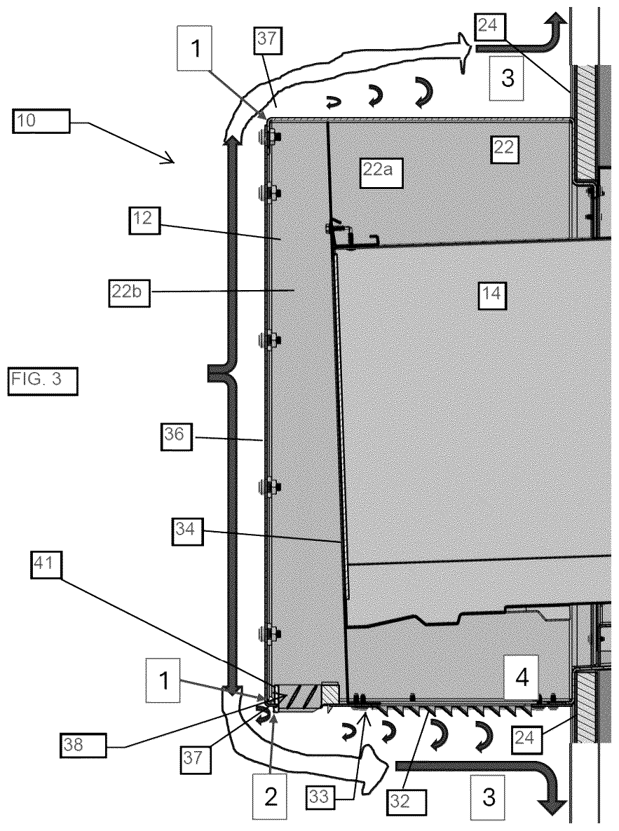

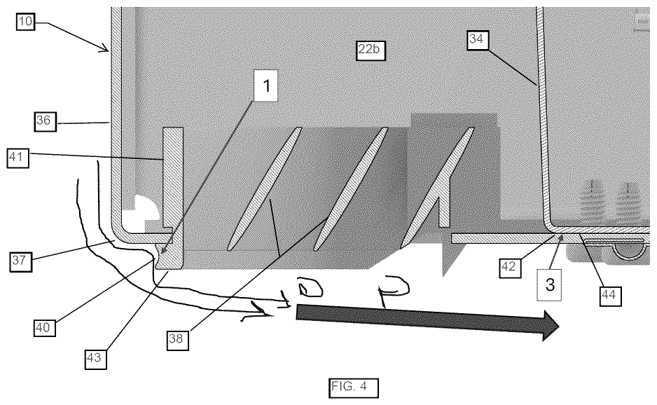

Continuing with reference to FIGS. 1-6, including with particular reference to FIG. 3, a representative approach for providing a transport function is shown. When vehicle 16 is in motion, air flow (shown by arrows) moving along front wall 36 of enclosure 10 around the bends 37 (shown at position 1 in FIG. 3) in the enclosure 10 separates from the housing 12. The exhaust louver 38 (shown at position 2 in FIG. 3) has a small concave feature 40 that directs any eddies that form around the bend 37 from entering it. See FIG. 4 for an enlarged view of this area. Airflow continues until it reaches the wall 24 of vehicle 16 (shown at position 3 of FIG. 3). At that point, it moves away from the enclosure 10 along the vertical wall 24. The intake louvers 32 (position 4 of FIG. 3) are pointed away from the airstream, keeping air and water from entering the openings defined by the louvers 32.

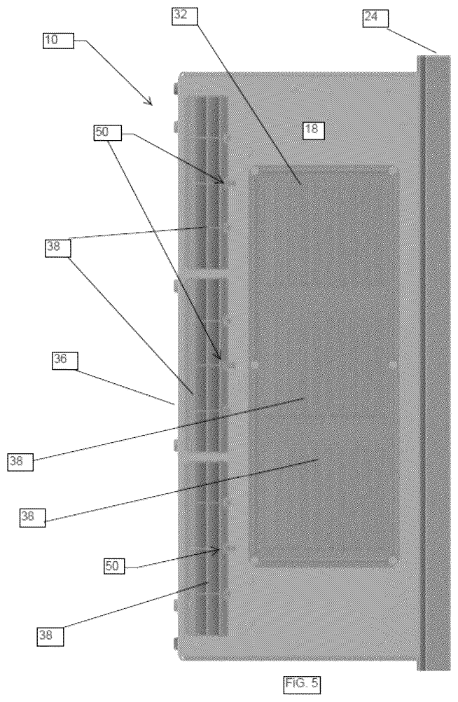

Continuing with reference to FIGS. 1-6, including with particular reference to FIGS. 4 and 5, as air moves around the front wall 36 of the enclosure 10, any air not separated from it or eddies of air that form encounter a small wall 41 with a concave feature 40 at its bottom 43 (shown at position 1 in FIG. 4). The concave feature 40 forces air further down and away from the exhaust louver 38 and subchamber 22b. This further reduces any outside air from entering it. If environmental water still enters this subchamber 22b, holes 50 behind the louver 38 allow it to drain (not visible in this section). A small seal 42 under the bottom edge 44 (shown at position 3 in FIG. 4) of the firewall 34 keeps moisture from moving into the subchamber 22a.

Following long-standing patent law convention, the terms “a”, “an”, and “the” refer to “one or more” when used in this application, including the claims. Thus, for example, reference to “an enclosure” includes a plurality of such enclosures, and so forth.

Unless otherwise indicated, all numbers expressing quantities, measures, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

The presently disclosed subject matter can be embodied in other forms without departure from the spirit and essential characteristics thereof. The embodiments described therefore are to be considered in all respects as illustrative and not restrictive. Although the presently disclosed subject matter has been described in terms of certain preferred embodiments, other embodiments that are apparent to those of ordinary skill in the art are also within the scope of the presently disclosed subject matter.

What is claimed is:

1. An enclosure for a vehicle air conditioning unit, the enclosure comprising:
a housing having an internal chamber, the internal chamber having a firewall positioned to define a first subchamber and a second subchamber, wherein the first subchamber is positioned proximate to a wall of the housing configured to be opposite a vehicle wall when the enclosure is mounted to a vehicle and the second subchamber is configured to be proximate to a vehicle wall when mounted to a vehicle and to receive an air conditioning unit; and
a first set of one or more exhaust louver on a periphery of the first subchamber and a second set of one or more intake louver on a periphery of the second subchamber, the first and second sets of louvers allowing for air flow into and out of the enclosure.

2. The enclosure of claim 1, wherein each louver of the first set of one or more exhaust louver on a periphery of the first subchamber is angled toward a vehicle wall of the vehicle to which the enclosure is mounted.

3. The enclosure of claim 1, wherein each louver of the second set of one or more intake louver on a periphery of the second subchamber is angled toward a vehicle wall of the vehicle to which the enclosure is mounted.

4. The enclosure of claim 1, wherein the periphery of the first subchamber and the periphery of the second subchamber are positioned on a bottom surface of the housing.

5. The enclosure of claim 1, further comprising a concave surface on a wall of the first set of one or more exhaust louver on the periphery of the first subchamber, wherein the wall is proximate to a wall of the housing configured to be opposite a vehicle wall when the enclosure is mounted to a vehicle.

6. A vehicle air conditioning unit assembly, the assembly comprising:
an enclosure for a vehicle air conditioning unit, the enclosure comprising:
a housing having an internal chamber, the internal chamber having a firewall positioned to define a first subchamber and a second subchamber, wherein the first subchamber is positioned proximate to a wall of the housing configured to be opposite a vehicle wall when the enclosure is mounted to a vehicle and the second subchamber is configured to be proximate to a vehicle wall when mounted to a vehicle and to receive an air conditioning unit; and
a first set of one or more exhaust louver on a periphery of the first subchamber and a second set of one or more intake louver on a periphery of the second subchamber, the first and second sets of louvers allowing for air flow into and out of the enclosure; and
an air conditioning unit.

7. The vehicle air conditioning unit assembly of claim 6, wherein each louver of the first set of one or more exhaust louver on a periphery of the first subchamber is angled toward a vehicle wall of the vehicle to which the enclosure is mounted.

8. The vehicle air conditioning unit assembly of claim 6, wherein each louver of the second set of one or more intake louver on a periphery of the second subchamber is angled toward a vehicle wall of the vehicle to which the enclosure is mounted.

9. The vehicle air conditioning unit assembly of claim 6, wherein the periphery of the first subchamber and the periphery of the second subchamber are positioned on a bottom surface of the housing.

10. The vehicle air conditioning unit assembly of claim 6, further comprising a concave surface on a wall of the first set of one or more exhaust louver on the periphery of the first subchamber, wherein the wall is proximate to a wall of the housing configured to be opposite a vehicle wall when the enclosure is mounted to a vehicle.

11. The vehicle air conditioning unit assembly of claim 6, wherein the assembly is mounted on a vehicle.

12. The vehicle air conditioning unit assembly of claim 7, wherein the vehicle is a travel trailer, a utility trailer, or a recreational vehicle.

13. A vehicle comprising an enclosure for a vehicle air conditioning unit of claim 1.

14. The vehicle of claim 9, comprising an air conditioning unit.

15. The vehicle of claim 9, wherein the vehicle is a travel trailer, a utility trailer, or a recreational vehicle.

16. A method for reducing or preventing leaking of environmental water into an air conditioning unit mounted on a vehicle, the method comprising enclosing an air conditioning unit mounted on a vehicle with an enclosure for a vehicle air conditioning unit, the enclosure comprising:
a housing having an internal chamber, the internal chamber having a firewall positioned to define a first subchamber and a second subchamber, wherein the first subchamber is positioned proximate to a wall of the housing configured to be opposite a vehicle wall when the enclosure is mounted to a vehicle and the second subchamber is configured to be proximate to a vehicle wall when mounted to a vehicle and to receive an air conditioning unit; and
a first set of one or more exhaust louver on a periphery of the first subchamber and a second set of one or more intake louver on a periphery of the second subchamber, the first and second sets of louvers allowing for air flow into and out of the enclosure.

17. The method of claim 16, wherein the vehicle is a travel trailer.

18. The method of claim 16, wherein the vehicle is a travel trailer, a utility trailer, or a recreational vehicle.
